(19) United States
(12) Patent Application Publication
(10) Pub. No.: US 2005/0233288 A1
(43) Pub. Date: Oct. 20, 2005

(54) Synchronized formative learning system, method, and computer program

(76) Inventor: Adrian Hylton McGrath, Christchurch (NZ)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/499,692

(22) PCT Filed: Dec. 20, 2002
(86) PCT No.: PCT/NZ02/00288

§ 371 Date: Jun. 8, 2005

(30) Foreign Application Priority Data
Dec. 21, 2001 (NZ) 516375
Dec. 24, 2001 (NZ) 516388
Dec. 24, 2001 (NZ) 516389

(51) Int. Cl. G09B 19/00

(52) U.S. Cl. 434/118

(57) ABSTRACT

The invention provides a method of learner-directed education comprising the steps of storing in computer memory one or more pedagogies representing topics to be mastered by a learner one or more of the pedagogies comprising one or more pedagogy items relating to sub-topics of the pedagogy; for one or more of the pedagogy items, storing in computer memory a plurality of instructional approaches to the pedagogy item, the instructional approaches comprising one or more locally stored media items and/or one or more links to remote media items; maintaining in computer memory a learner profile for each learner; providing the learner with a leaning interface to the one or more pedagogies stored in computer memory; updating the learner profile for a learner based on the interaction of the learner with the one or more media items; and displaying to the learner an indication of their mastery of pedagogical items as the learner profile for that learner is updated. The invention also provides a related system and computer program for learner-directed education.

### FIELD OF INVENTION

The invention relates to educational systems and in particular to a system, method and computer program for a learner-directed formative learning system using synchronised media.

### BACKGROUND TO INVENTION

Typically in an educational environment, a learner finds themselves in a class with large numbers of other learners and has a passive role in the learning process. The learner listens to or observes a class and is sometimes asked to perform specific practice tasks. The learner is usually then expected to show what they have learned by participating in some form of assessment.

This assessment is usually summative, meaning that the user is asked to perform a series of tasks, usually within a time limit, and is given feedback only after those tasks are completed. This would be the case if, for example, a student attended classes for a semester and then took an exam at the end. Only once the exam had been marked and graded would the student and teacher have a good idea of what learning objectives had been achieved by the student and which had not.

However more often than not, such summative assessments are primarily used to assist in ranking learners and also in banding learners into class groups which are then provided with a single teacher. Thus the results of these assessments often give the learner a better idea of how they are ranked in comparison to other learners rather than giving them a clear idea of what they have learned and have not learned per se.

It is well recognised that the ideal learning environment involves interaction between a learner and a personal teacher who interacts with the learner on a one-to-one basis. The teacher observes what material the learner has understood and what they have not and will proceed with further appropriate instruction accordingly. This interaction usually allows the learner to be individually engaged in and able to control the learning process since their learning progress determines their learning path. This type of learning process is driven by what is known as formative assessment.

When formative assessment is used a learner will usually have a better understanding of what they need to learn and will be more aware when they come to understand something they previously did not understand. Thus the learner is far more engaged in the learning process.

Unfortunately economic constraints mean that it is generally impossible to provide a personal teacher for every learner in an educational environment.

While computer based educational systems exist which try to engage learners by providing instant feedback, such systems are almost always designed around the normal classroom paradigm in that they lead a student through a lesson or practice exercise without allowing the student to direct or understand their own learning path.

It would be useful to have a system that is capable of providing automated formative assessment and allow a user to learn at their own pace through the synchronisation of different media through an interface.

### SUMMARY OF INVENTION

In broad terms in one form the invention provides a method of learner-directed education comprising the steps of storing in computer memory one or more pedagogies representing topics to be mastered by a learner one or more of the pedagogies comprising one or more pedagogy items relating to sub-topics of the pedagogy; for one or more of the pedagogy items, storing in computer memory a plurality of instructional approaches to the pedagogy item, the instructional approaches comprising one or more locally stored media items and/or one or more links to remote media items; maintaining in computer memory a learner profile for each learner; providing the learner with a learning interface to the one or more pedagogies stored in computer memory; updating the learner profile for a learner based on the interaction of the learner with the one or more media items; and displaying to the learner an indication of their mastery of pedagogical items as the learner profile for that learner is updated.

### BRIEF DESCRIPTION OF THE FIGURES

Preferred forms of the synchronised formative learning system, method, and computer program will now be described with reference to the accompanying figures in which:

FIG. 1 shows a block diagram of a system in which one form of the invention may be implemented;

FIG. 2 shows the preferred system architecture of hardware on which the present invention may be implemented;

FIG. 3 shows one preferred mode of implementation of the invention;

FIG. 4 shows a preferred mode of use of the invention;

FIG. 5 shows a preferred mode of use of the invention;

FIG. 6 shows a preferred mode of use of the invention;

FIG. 7 shows a preferred mode of use of the invention;

FIG. 8 shows a preferred mode of use of the invention;

FIG. 9 shows a preferred mode of use of the invention;

FIG. 10 shows a preferred mode of use of the invention;

FIG. 11 shows a preferred mode of use of the invention;

FIG. 12 shows a preferred mode of use of the invention;

FIG. 13 shows a preferred mode of use of the invention;

FIG. 14 shows a preferred mode of use of the invention;

FIG. 15 shows a preferred mode of use of the invention;

FIG. 16 shows a preferred mode of use of the invention;

FIG. 17 shows a preferred mode of use of the invention;

FIG. 18 shows a preferred mode of use of the invention;

FIG. 19 shows a preferred mode of use of the invention;

FIG. 20 shows a preferred mode of use of the invention;

FIG. 21 shows a preferred mode of use of the invention;

FIG. 22 shows a preferred mode of use of the invention;

FIG. 23 shows a preferred mode of use of the invention;

FIG. 24 shows a preferred mode of use of the invention;

FIG. 25 shows a preferred mode of use of the invention;

FIG. 26 shows a preferred mode of use of the invention;

FIG. 27 shows a preferred mode of use of the invention;

FIG. 28 shows a preferred mode of use of the invention;

FIG. 29 shows a preferred mode of use of the invention;

FIG. 30 shows a preferred mode of use of the invention;

FIG. 31 shows a preferred mode of use of the invention;

FIG. 32 shows a preferred mode of use of the invention;

FIG. 33 shows a preferred mode of use of the invention; and

FIG. 34 shows a preferred mode of use of the invention.

### DETAILED DESCRIPTION OF PREFERRED FORMS

FIG. 1 illustrates a block diagram of the preferred system 100 in which one form of the present invention 105 may be implemented.

The system 100 preferably includes one or more clients 110, for example 110A, 110B, 110C, 110D, 110E and 110F, which each may comprise a personal computer or workstation described below. Each client 110 is interfaced to the invention 105 as shown in FIG. 1. Each client could be connected directly to the invention, could be connected through a local area network or LAN, or could be connected through the Internet.

Clients 110A and 110B, for example, are connected to a network 120, such as a local area network or LAN. The network 120 could be connected to a suitable network server 125 and communicate with the invention as shown. Client 110C is shown connected directly to the invention 105. Clients 110D, 110E, and 110F are shown connected to the Internet 130. Client 110D is shown as connected to the Internet 130 with a dial-up connection and clients 110E and 110F are shown connected to a network 140 such as a local area network or LAN, with the network 140 connected to a suitable network server 145.

It will be appreciated that a client 110 may be connected to the invention 105 directly, via a network or via the Internet 130 by any available means such as for example wireless or cable.

One preferred form of the invention 105 comprises a personal computer or workstation operating under the control of appropriate operating and application software having a data memory 160 connected to a server or workstation 150.

Data memory 160 stores all local data for the method, system and computer program of the invention. The invention may also access remote resources 180 via the Internet 130 which are then incorporated into the invention.

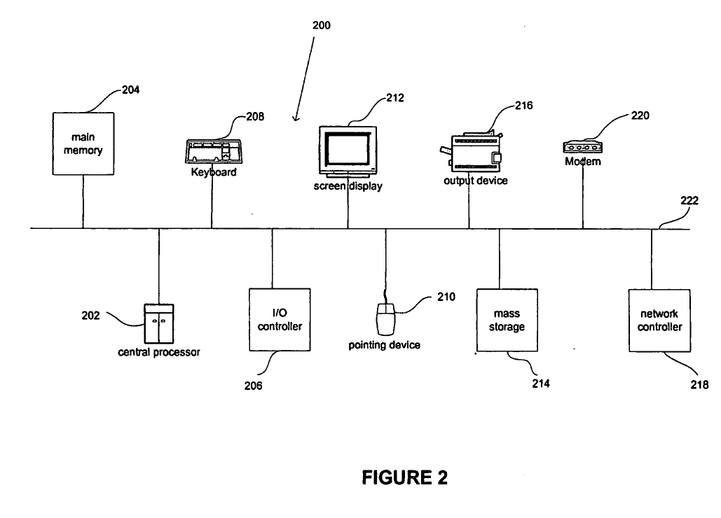

FIG. 2 shows the preferred system architecture of a client 110 or invention 105. The computer system 200 typically comprises a central processor 202, a main memory 204, for example RAM, and an input/output controller 206. The computer system 200 also comprises peripherals such as a keyboard 208, a pointing device 210, for example a mouse, touch pad, or track ball, a display or screen device 212, a mass storage memory 214, for example a hard disk, floppy disc or optical disc, and an output device 216 such as a printer. The system 200 could also include a network interface card or controller 218 and/or a modem 220. The individual components of the system 200 could communicate through a system bus 222.

A learner or other user may access the invention via a client 110 or directly at server/workstation 150.

Data used by the invention may be stored in data memory 160 as mentioned above. It will be appreciated that data memory 160 may take the form of a local hard drive, CD Rom or other removable data storage media, may be distributed over a network or may comprise any combination of these.

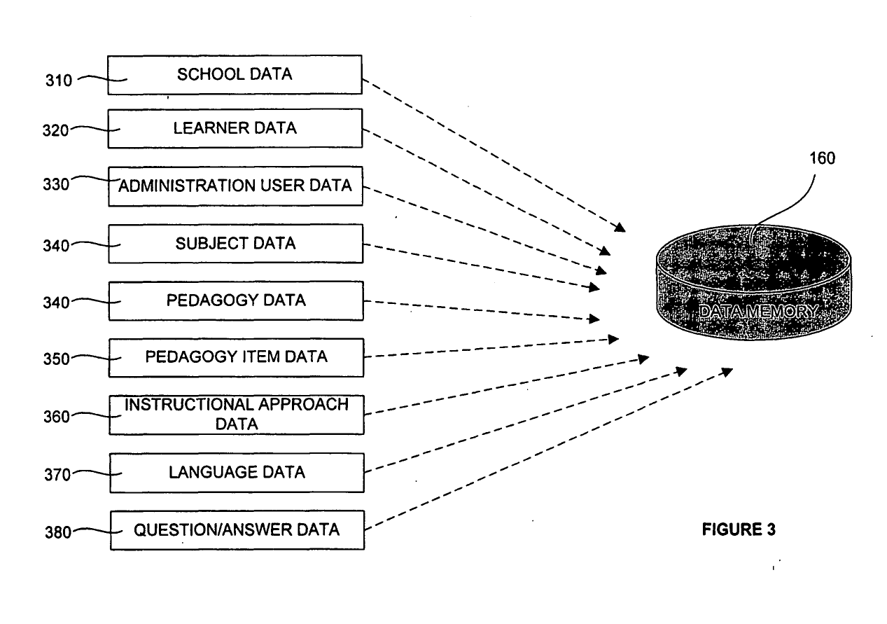

FIG. 3 shows examples of the type of data which may be stored in data memory 160.

The invention may store school data 310 relating a school that is using the invention. School data may include the school name, region, country and any other relevant information.

The invention may also store learner data 320 about one or more learners who use or access the invention. Learner data may include such information as the learner's name, age, gender, school, region, class, level of study (for example year eight, year nine, freshman, sophomore or any other such classification commonly used in the country of use), and any other statistical information that may be relevant.

The invention may store pertinent Learner data in a Learner Profile which may be used to keep track of a Learner's learning progress. Data relating to the progress of a learner may also be stored in Data memory 160.

It is envisaged that a curriculum will be specified for each learner, setting out the prescribed subject matter for the Learner to study, which may also be stored in Data memory 160. A curriculum may be divided by subject matter, such as, for example, Maths, Physics, Chemistry or Biology. The curriculum may then be further divided out into clusters of pedagogies.

A pedagogy represents a more specific topic for study within a broad subject. In the invention a pedagogy is a topic which has been prescribed for a learner to master to a specified level depending on the class grouping of the student. For convenience, pedagogies may be grouped into clusters of related topics referred to as Pedagogy Clusters.

The level of mastery prescribed for a learner for particular pedagogies may be set as an Assessment Level or a Learning Level and stored with the other learner data 320. An assessment level indicates that the learner is expected to learn that material to the level specified and will be assessed on it. A Learning level is also a level of mastery set for a student to attain, but may specify a level to which the student may not necessarily be assessed. If a student has higher learning levels than assessment level it may be that the learner has progressed beyond the parameters required for their level of study and are therefore being provided with extra learning objectives to keep them engaged, even though such learning objectives may not form any part of the learners final assessment.

Different Leaning and Assessment Levels may be set for different pedagogies for each individual student.

A pedagogy may comprise one or more Pedagogy Items, which are more specific learning tasks or topics. Different Learning and Assessment Levels may also be set for different Pedagogy Items for each individual student.

The invention may also store Administration user data 330 relating to user's of the invention who are not learners, such as, for example, teachers. The Administration user data may contain such information as the permission levels for the user to make changes to the system configuration or, in the case of a teacher, the level of study to which the teacher is permitted or qualified to teach.

The invention may also store Subject data 340 relating to the subjects prescribed for study by learners, for example Maths, Biology, Physics and so on, such as the pedagogy clusters each subject comprises.

The invention may also store information relating to specific pedagogies 340 within a Subject including the Pedagogy Cluster to which the pedagogy belongs, the Pedagogy items within it, and the Assessment, Learning, and Teaching level relevant to it.

The invention may also store information relating to specific Pedagogy Items 350.

The invention may further store information relating to the instructional approaches which can be accessed by a Learner for a particualar Pedagogy Item.

The invention may also store information relating to the languages in which a may access the invention, for example English, Maori, Spanish and so on.

The invention may also store data relating to questions and answers that may be used to assess a learner's progress. In some cases this may include information about the steps that may be taken to solve a problem presented to a learner as a question, and the different paths that may be taken by a learner to arrive at a correct response or an incorrect response.

Data for the invention, such as that described above for example, may be stored in a relational database structure or any other appropriate data structure. It will be appreciated that the particular data stored in data memory 160 may vary depending on the application of the invention. For example, where the invention is being used for learners who are studying from home it would not be necessary or relevant to store school data.

The invention may be embodied as a computer program running on workstation/server 150 and accessing data in data memory 160 or retrieved over a wide area network or the Internet. The typical functions of one embodiment of the computer program of the invention is described below.

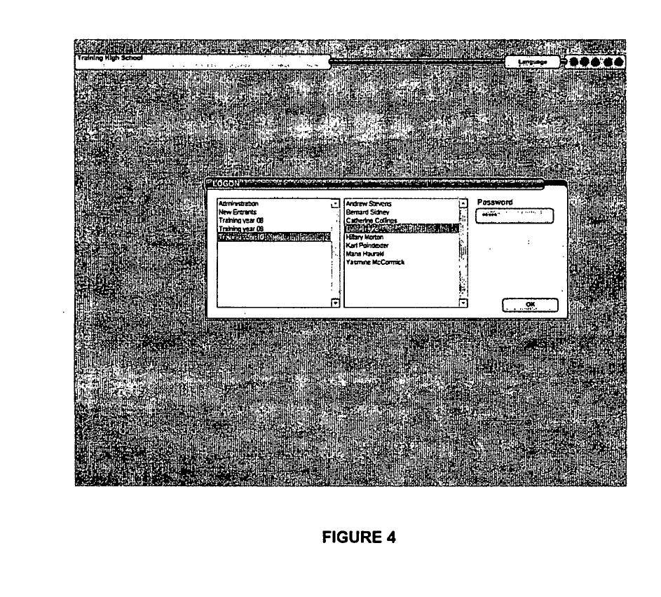

FIG. 4 shows a preferred method of accessing the invention 105. Learner profile data may include a student login and password as shown in FIG. 4. For a learner to log on the learner must select their level of study and name and enter their password as shown.

Likewise an administration user such as a teacher may logon with an administration login and password stored in the Administration User data. An example path of an administration user through the preferred method and computer program of the invention is described below.

If the user is a teacher then the invention may allow the user to access and modify student and student curriculum data. This functionality of the invention may be referred to as the curriculum builder.

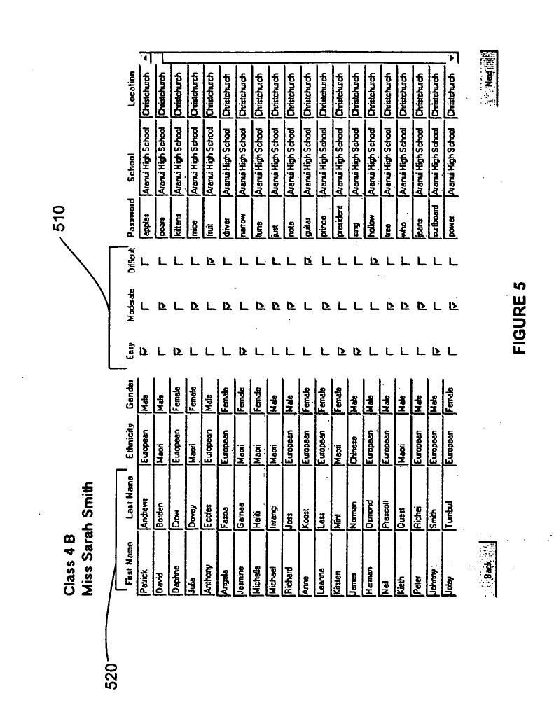

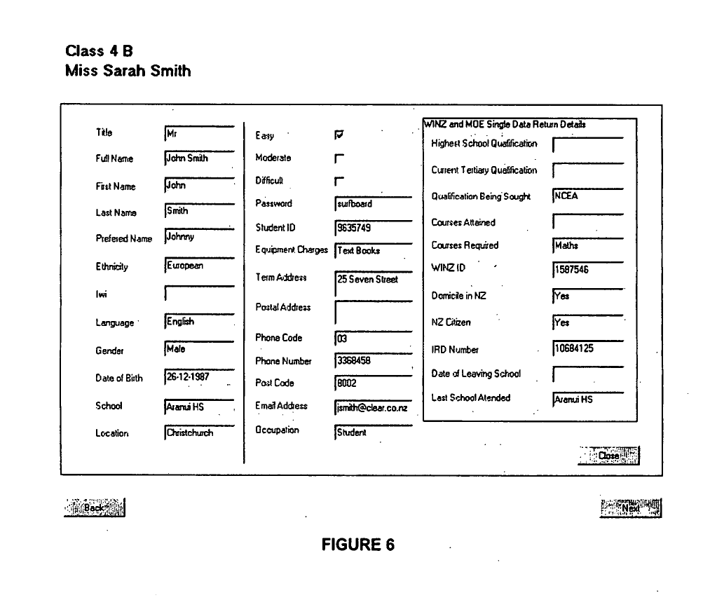

FIG. 5 shows some sample student data as viewed by a teacher in one preferred embodiment of the invention. Preferably a teacher will only be able to view and modify data for student's in their own classes. The data available in this view includes each learner's name 520, overall learning level 510 and other details. The teacher may then drill down to view and modify a particular learner's details as shown in FIG. 6.

FIG. 6 shows an administration user interface which may be used by a teacher to modify basic student data not related to student progress including overall learning level. In this embodiment the teacher is given the option of setting the overall learning level to easy, moderate, or hard.

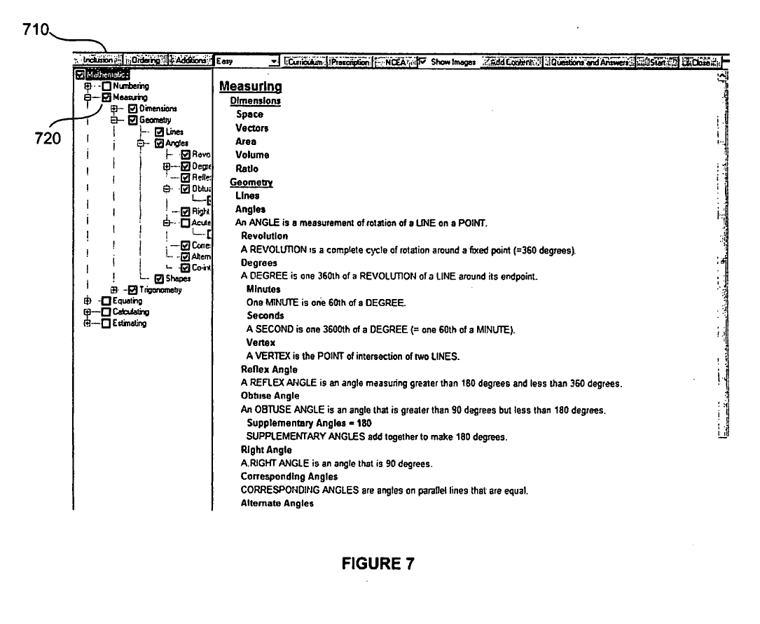

If the teacher wishes to modify the curriculum of that particular learner they may proceed to a screen such as that shown in FIG. 7.

By selecting the Inclusion Function 710 the teacher may select the pedagogy clusters, pedagogies, and pedagogy items that should be included in the learner's curriculum by checking or un-checking the boxes. For example, checked box 720 indicates that pedagogy cluster Measuring is to be included in the learner's curriculum.

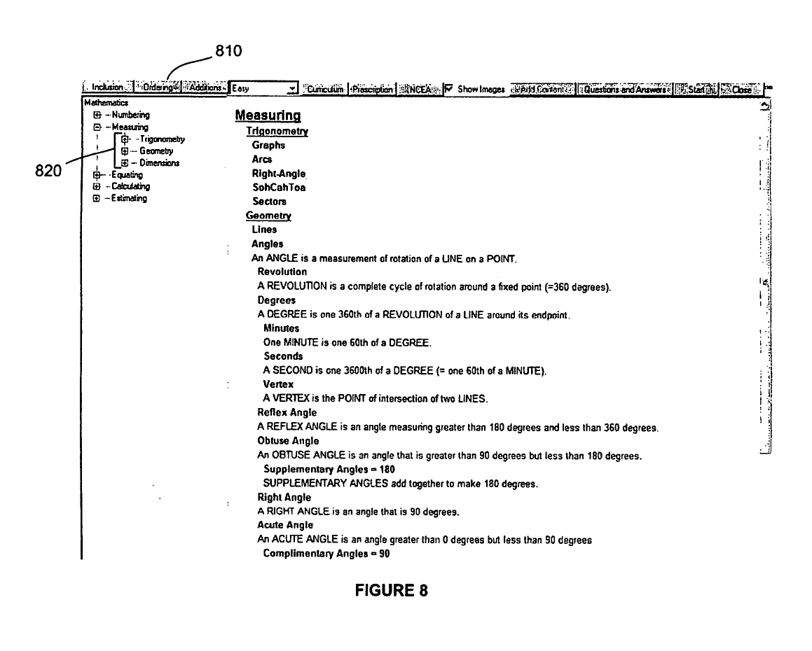

FIG. 8 shows the use of the Ordering function 810, which allows the teacher to select a preferred ordering for the pedagogy clusters, pedagogies and pedagogy items by dragging and dropping them into order. For example, pedagogy clusters Trigonometry, Geometry, and Dimensions 820 could be re-ordered by dragging the word Dimensions to a new position in the list.

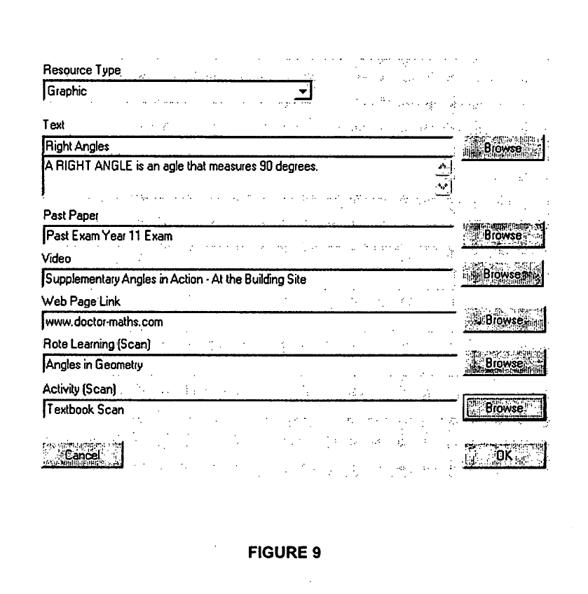

FIG. 9 shows a screen that may be displayed by a teacher to enter a piece of information or media item from their own data library or from the Internet and attach it to a specific pedagogy item. This example shows a media item being added to a pedagogy entitled Supplementary Angles.

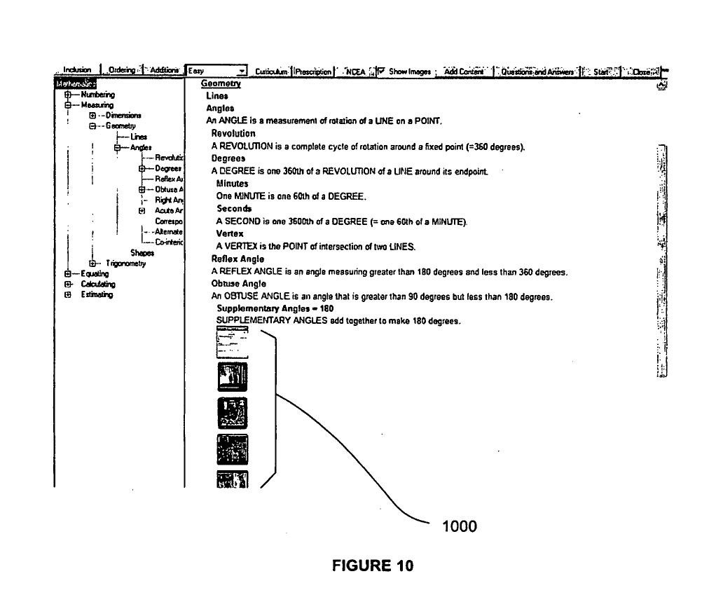

New media items added to a pedagogy 1000 may then be displayed as previews as shown in FIG. 10.

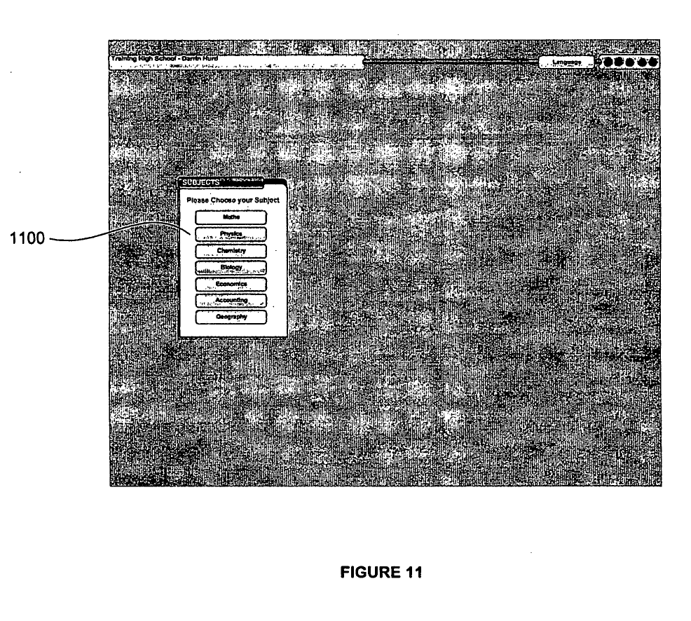

The typical path(s) of a learner through the method and computer program of the system will now be described by way of example beginning from the login step shown in FIG. 4. Once the invention has verified the student login data the learner will be presented with a menu 1100 showing a selection of subjects included in their curriculum or included in their study plan as shown in FIG. 11. From this menu the student will select the subject that they would like to learn. In FIG. 11 the learner has selected Maths.

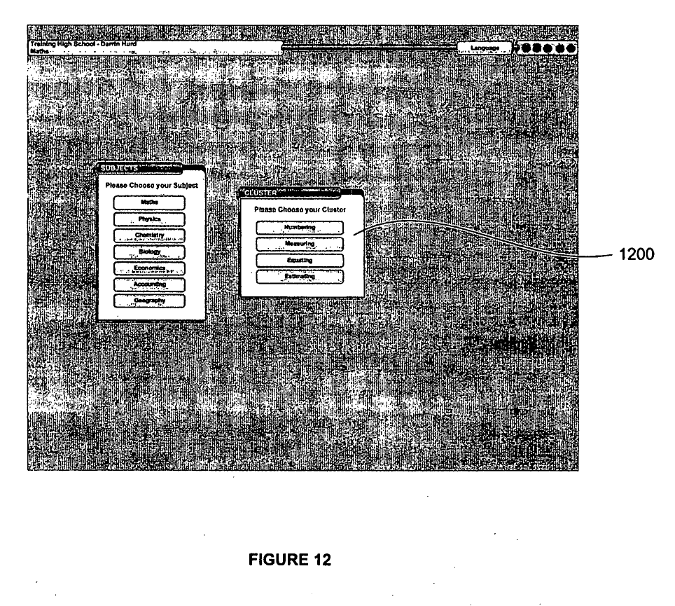

Clicking on a menu item in the subject menu 1100 will open a new menu with different pedagogy clusters as shown in FIG. 12. Cluster headings represent an initial break down of the subject matter into broad topics and each of these broad topics comprises one or more pedagogies.

Following the example from FIG. 11, clicking on the Maths menu item opens up a new pedagogy cluster menu 1200 containing four pedagogy clusters: Numbering, Measuring, Equating, and Estimating. In this example the learner has selected Equating. Each subject may contain one or more pedagogy-clusters.

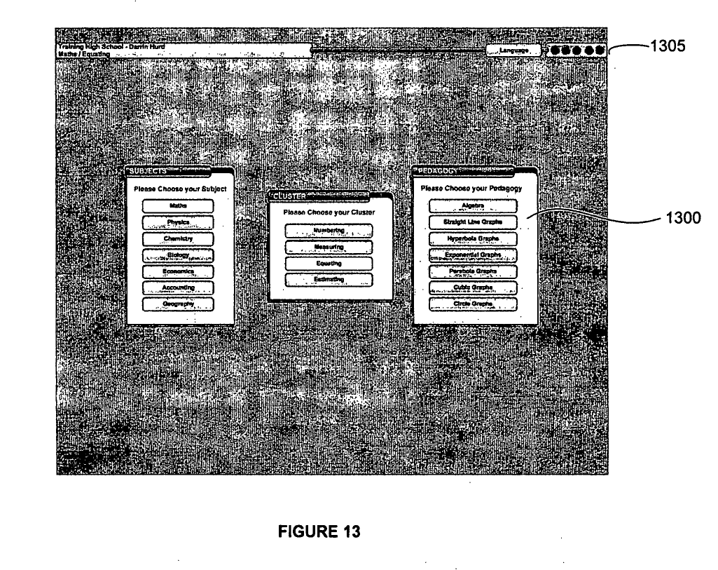

As shown in FIG. 13, clicking on a pedagogy cluster will open up a menu 1300 of all the pedagogies that fall under the heading of the pedagogy cluster. Each pedagogy cluster may have one or more pedagogies. In the example in FIG. 13 the learner has selected the Equating pedagogy cluster and the invention has opened a further menu 1300 with seven pedagogies: Algebra, Straight Line Graphs, Hyperbola Graphs, Exponential Graphs, Parabola Graphs, Cubic Graphs, and Circle Graphs. However, other pedagogies such as for example the Numbering pedagogy may contain a different number of pedagogy items.

If the learner wishes to change their mind about any of their study choices they may simply select a different pedagogy cluster from the pedagogy cluster menu 1200 or select a different subject from the subject menu 1100. The learner can return to the menus at any time during their session by using the navigation buttons 1305 as shown in FIG. 13.

However, in the example shown in FIG. 13, the learner has selected to proceed and has selected the Straight Line Graph pedagogy. The user will then enter the learning environment to access the learning interface.

If the user has never accessed the selected pedagogy before the system may administer a pre-test to the learner. The purpose of the pre-test is to test the learner's pre-existing knowledge of the pedagogy. The pre-test may take the form of a simple multi-choice or short answer arrangement and may comprise a problem to be solved or a game.

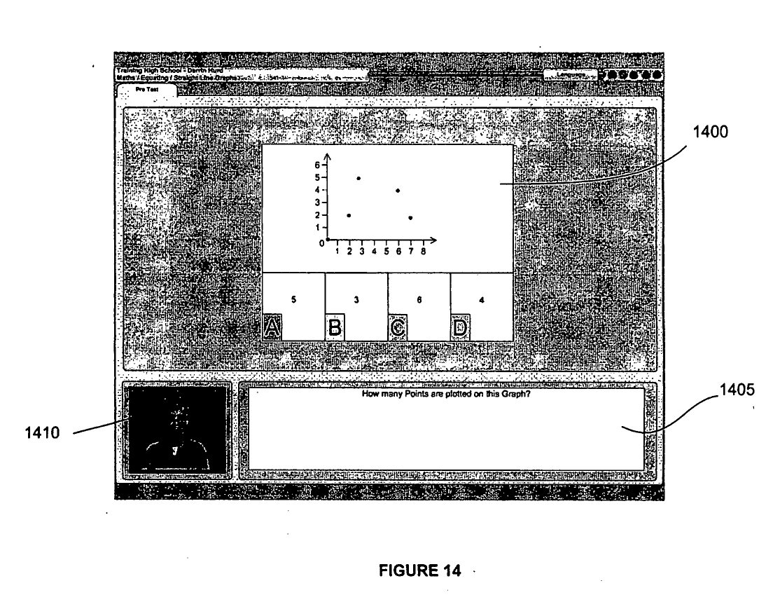

FIG. 14 shows a possible arrangement for a pre-test for the Straight Line Graph pedagogy. A diagram 1400 is displayed in the centre of the screen with four possible answers: A, B, C, and D. The question may be displayed at the bottom of the screen. Footage of a person reading the question aloud may also be displayed 1410. The user can then select the answer they think is correct, for example by clicking on it.

A pedagogy will normally be divided into sub-topics. In the present specification such sub-topics within a pedagogy are referred to as pedagogy items. Each pedagogy will comprise one or more pedagogy items. For a pre-test to be effective more than one question should be included in the test for each pedagogy item.

In the following example we will assume that three questions are asked for each pedagogy item in the selected pedagogy, each of the three questions having a different level of difficulty.

Each question has an assessment level associated with it as described above and this is used in combination with the responses of the learner during the pre-test to determine the level of mastery with which the learner is entering the pedagogy. This information is stored in the learner profile for that learner. This assessment level can be set by a teacher or course supervisor in the curriculum builder.

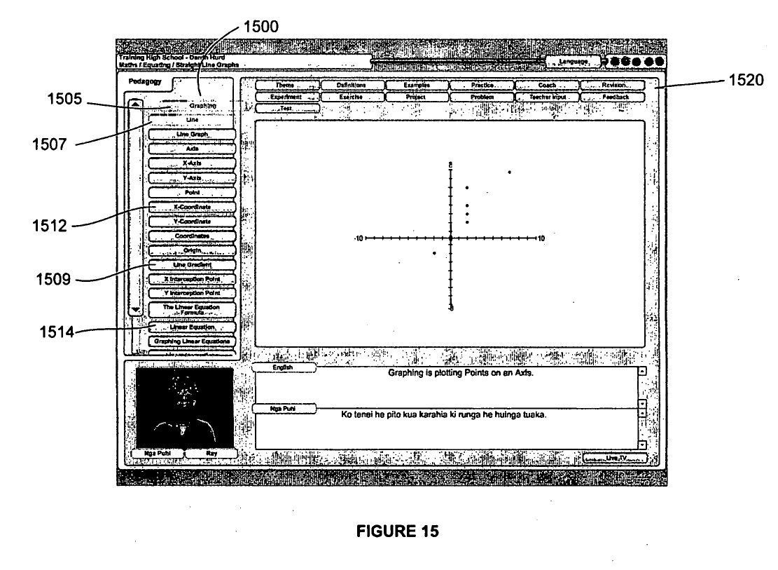

When the learner has completed the pre-test they may enter the pedagogy as shown in FIG. 15. A menu 1500 represents the pedagogy items in the selected pedagogy.

Pedagogy items for which the learner demonstrated a satisfactory level of mastery in the pre-test may be greyed-out. In FIG. 15 for example the Graphing pedagogy item 1505 and the Line pedagogy item 1507 have been greyed out, indicating that the learner already has an acceptable level of mastery of those pedagogy items.

Learner's may still access pedagogy item's that have been greyed out. Greying out those pedagogical items of which the learner has a good knowledge simply allows the learner to measure their own achievement at a glance and focus their learning efforts on those learning objectives not yet achieved.

Further incremental indications of the learner's level of mastery and progress for a pedagogical item may be given to the learner for example, in the form of three small rectangles in the top left hand corner of each pedagogical item button as shown in FIG. 15. These rectangles may be colour coded.

The line Line Gradient pedagogy item button 1509, for example, has a single rectangle in the top left hand corner, indicating that the learner has some elementary knowledge of that pedagogy item. The first rectangle may green in colour. By comparison, the X-coordinate pedagogy item button has two rectangles in the top left hand corner, indicating a more advanced level of mastery of that pedagogy item by the learner. The second rectangle may be orange in colour.

Pedagogy items for which the learner's knowledge merits three rectangles, for example the Graphing pedagogy item 1505 and the Line pedagogy item 1507, automatically become greyed out. The third rectangle may be of a stronger colour such as red, for example.

In FIG. 15, the pedagogy item button for Linear Equations 1514 does not have any indications of learner mastery, this would mean that the learner has little or no mastery of that pedagogy item.

For each pedagogy item the learner may select from one or more instructional approaches to the item. A set of tabs for these instructional approaches is shown in FIG. 15 at 1520. The instructional approaches that are available may not be identical for each pedagogy item. Elective access to multiple instructional approaches allows the learner to take a multi-lateral approach to their learning.

Each instructional approach may be made up of one or more media items such as, for example, images, animations, text, video, and audio. Some preferred instructional approaches are described below by way of example.

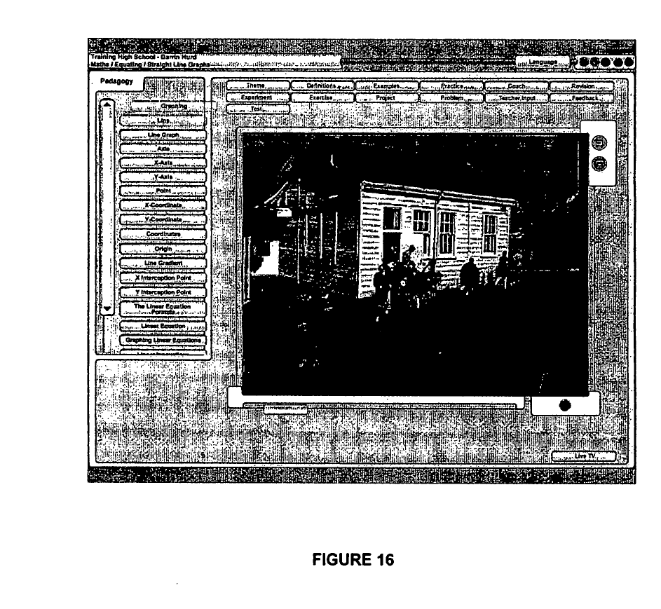

For example, the “Theme” instructional approach as shown in FIG. 16 comprises a video that gives examples of the selected pedagogy item in a real world situation. The videos may be created by the students and the teachers.

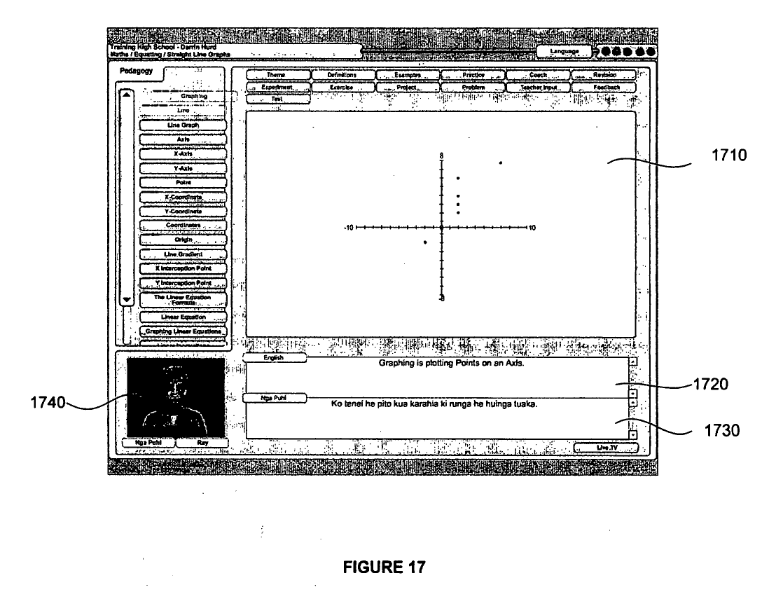

The “Definitions” instructional approach sets out some basic information about the pedagogy item as shown in FIG. 17. A plurality of media may be used to convey this basic information simultaneously. The use of multiple signals to transmit the information to the learner leads to reinforcement of the message and is likely to engage learners with many different learning styles.

A diagram 1710 may be displayed illustrating the principle being explained. The diagram may just as easily be an animation of some sort. A text definition 1720 may be displayed at the same time. The invention may display such text definitions in more than one language at a time as shown at 1730 where the definition shown at 1720 in English has been displayed in the Maori language as well.

This multi-language feature may be especially useful in countries with more than one official language, or in circumstances when the language in which a learner is studying is not the learner's first language.

In an especially preferred embodiment of the invention all text on the learning interface including operating system text and text in animations can be changed to another language.

Footage may also be displayed of a person reciting the text shown at 1740. Alternatively if the learner elects, the person may recite the alternate language text shown at 1730.

Preferably the learner may modify aspects of some learning approaches to suit their preferred learning style. This may be, for example, by selecting an alternative language for instruction or by selecting a different person to be displayed at 1740. A particular learner may, for example, be more receptive to a female teacher and wish to change the settings accordingly.

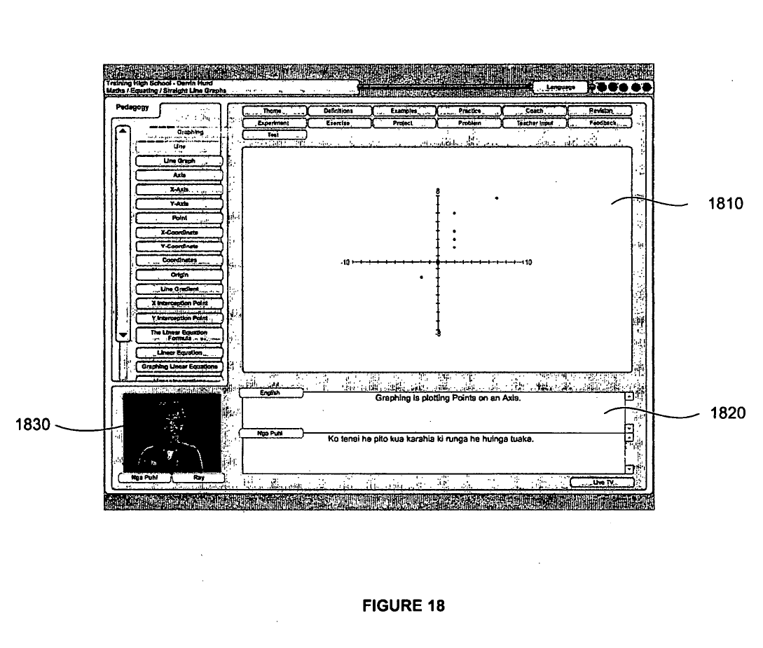

The “Examples” learning approach may display one or more examples of the pedagogy item as shown in FIG. 18.

The example may be expressed by a diagram or animation 1810 playing in the centre of the screen demonstrating the pedagogy item. An accompanying text 1820 for the example may also be displayed and footage of a person 1830 may be shown reading the text of the example out loud. Once again the language of the text or recital may be changed by election of the learner or the learner may elect to view and hear the examples in two languages.

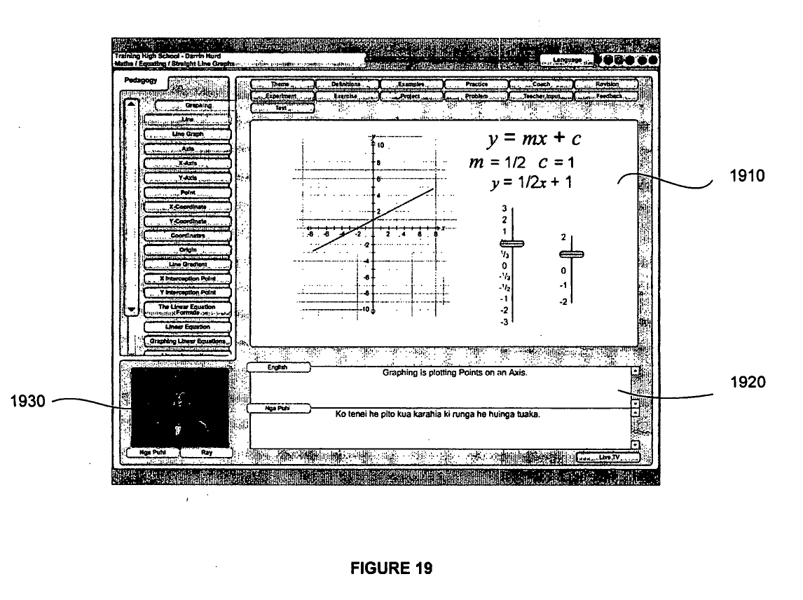

The “Practice” instructional approach is shown in FIG. 19 and may display an interactive tool 1910 that is related to the chosen pedagogy item where the learner may play and experiment.

Instructions 1920 may be displayed at the bottom of the screen and a person 1930 may read the instructions out loud.

Once again two languages may be shown simultaneously and both chosen languages may be spoken aloud.

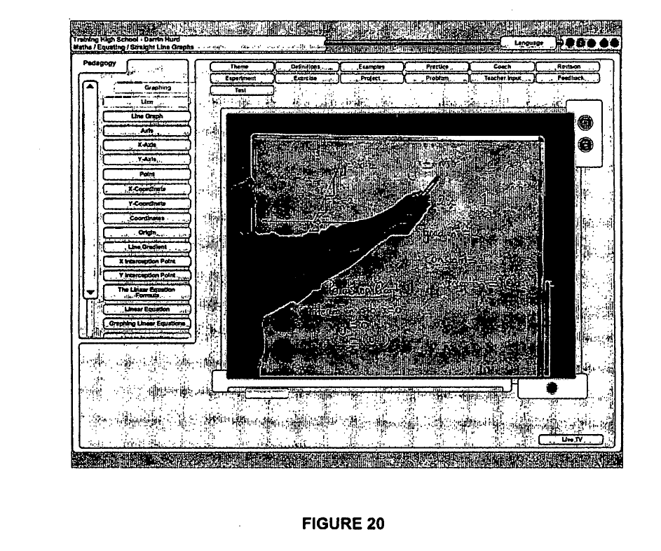

The “Coach” instructional approach may comprise a video of a teacher or a student demonstrating an example of the selected pedagogy item using either a whiteboard or projector as shown in FIG. 20.

When the learner feels confident with all the pedagogy items in the pedagogy they may elect to take a post-test. This is essentially similar to the pre-test described above but it will act as an ongoing or continual assessment of the learner's progress for the particular pedagogy and may ask questions that have not yet been asked.

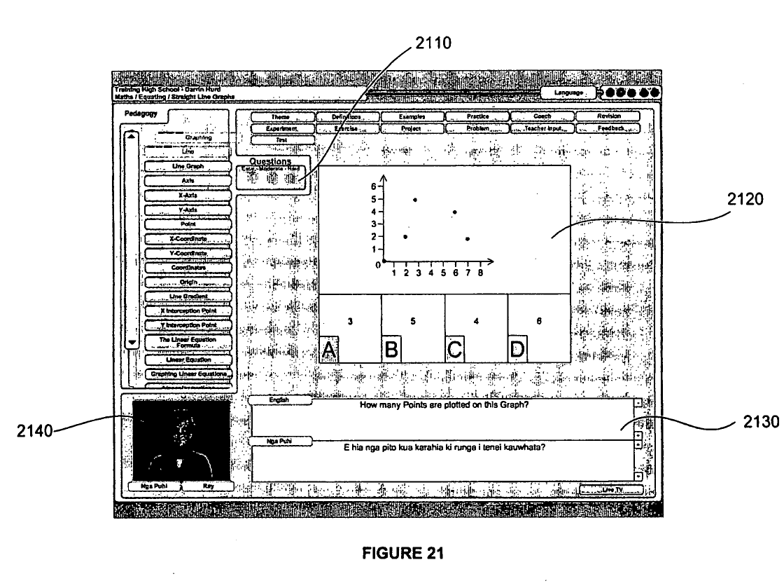

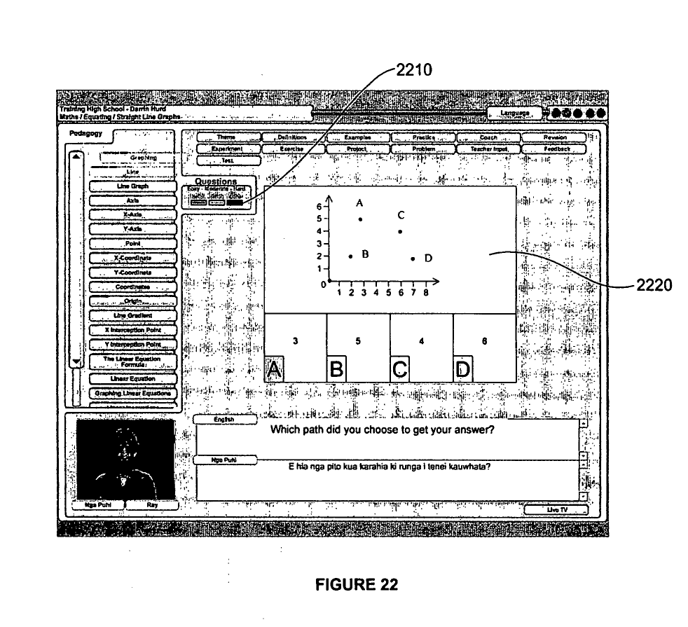

The “Revision” instructional approach may test the user's knowledge of the selected pedagogy item by giving them three multiple choice questions to answer based on that pedagogy item as shown in FIGS. 21 and 22. The questions will be of progressive difficulty from easy to hard and may be drawn from the same question/answer data as that used for the pre and post-tests.

Revision of this type offers the learner the opportunity to update their learner profile and see their progress indicated on the pedagogy theme buttons.

For each Pedagogy Item the invention may display a revision question menu with a series of buttons 2210. In this case the learner may choose from three questions of progressive difficulty easy, moderate, or hard. The user may select the difficulty of the question they wish to attempt from a revision question menu 2110. A diagram of a question of the selected difficulty may then be displayed 2120, the question may be written in text in one or more languages, and a person 2140 may read the question out loud, again in one or more languages. The user may then select the answer they consider to be correct.

If the learner has already answered a question correctly in a pre or post-test the circle button representing the question in the revision question menu 2110 may appear green, and/or a tick may appear over the circle button.

If the learner has answered the question incorrectly or has not been previously asked the question in a pre or post test the circle button representing the question in the revision question menu 2110 will not be coloured in.

If, after revising and study the learner takes another post-test and answers correctly a question previously answered incorrectly the circle button for that question will be coloured orange and/or have a tick over it the next time the learner visits the revision instructional approach and is presented with a circle button for that question. The circle button will appear red if a learner has answered the question correctly in a pre- or post-test on the third try.

FIG. 22 shows an additional feature of the Revision learning approach which allows a learner to work through questions they have already answered in pre or post tests and to show them either where they have gone wrong in answering that question or what alternative strategies there may be to answer the question that may be more efficient or logical.

If the learner has already attempted a question in a pre or post test the circle button representing that button will have an indication on it, for example a coloured rectangle 2210, to show that this is the case. The learner may then elect to work through that problem and a diagram demonstrating the first steps in solving the problem 2220.

The learner is then asked which of a plurality of possible paths they chose to arrive at their answer. If the learner did not use any of the possible paths they may indicate this and the invention will then take them through the best path, step by step, that would have resulted in a correct answer.

If the learner selected a correct path but not the best, or most efficient path, the invention may congratulate them on solving the problem and then take them through the path of the more efficient solution strategy.

Likewise if the learner has taken some steps on a correct path but has then made an error, the invention can then explain that error to them and take them through the remaining steps to arrive at the correct solution.

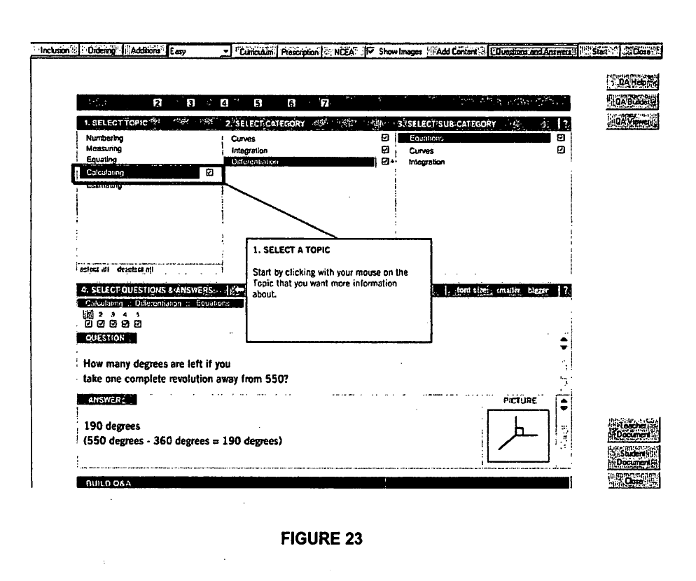

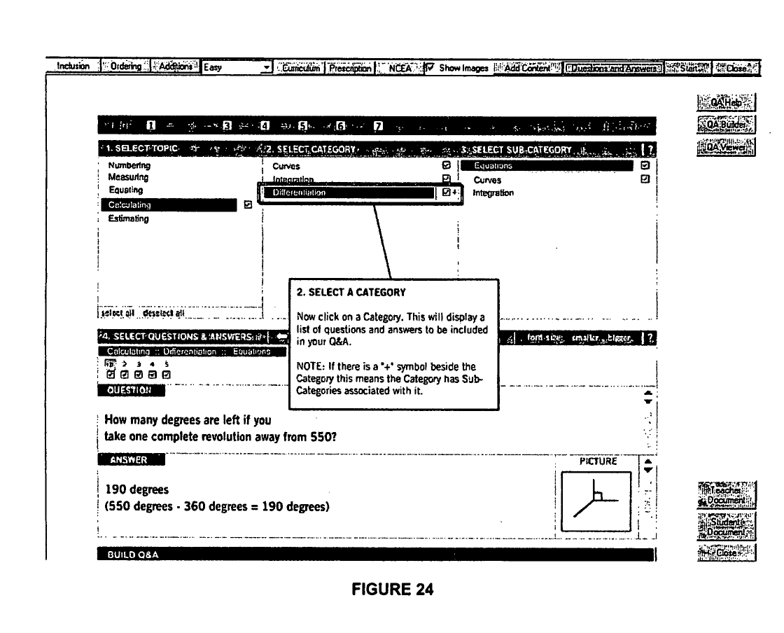

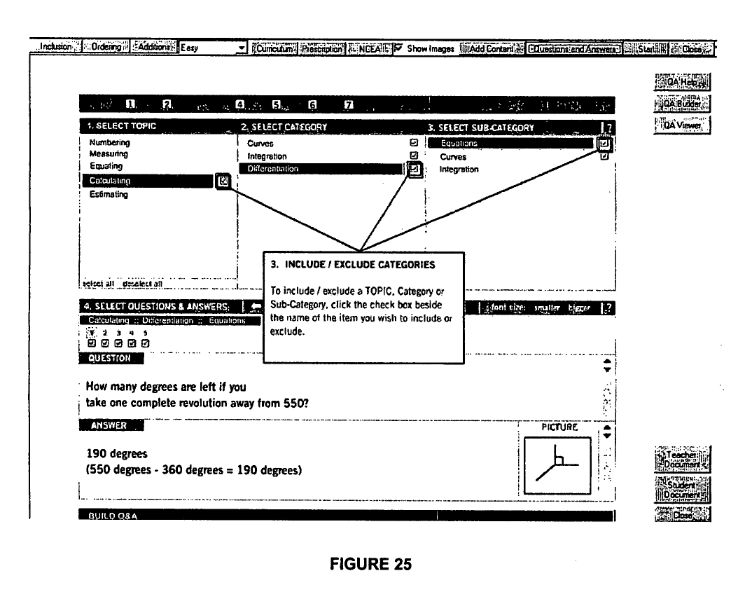

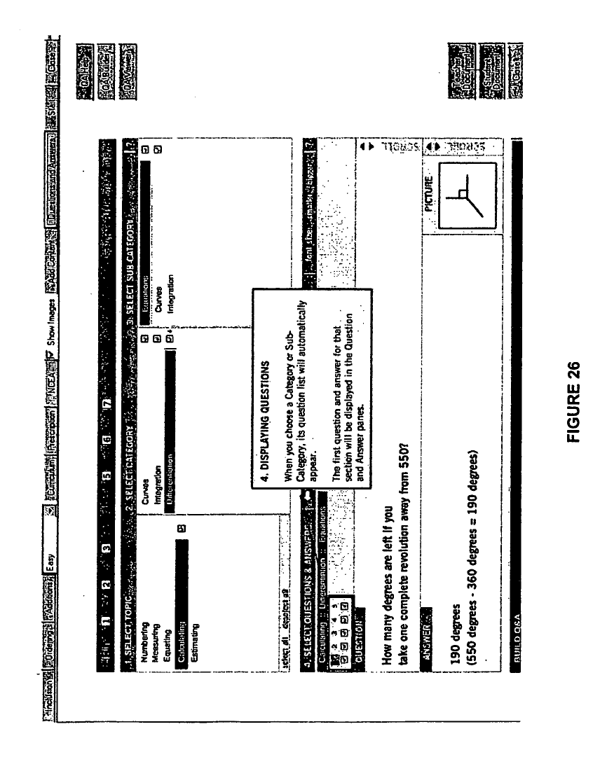

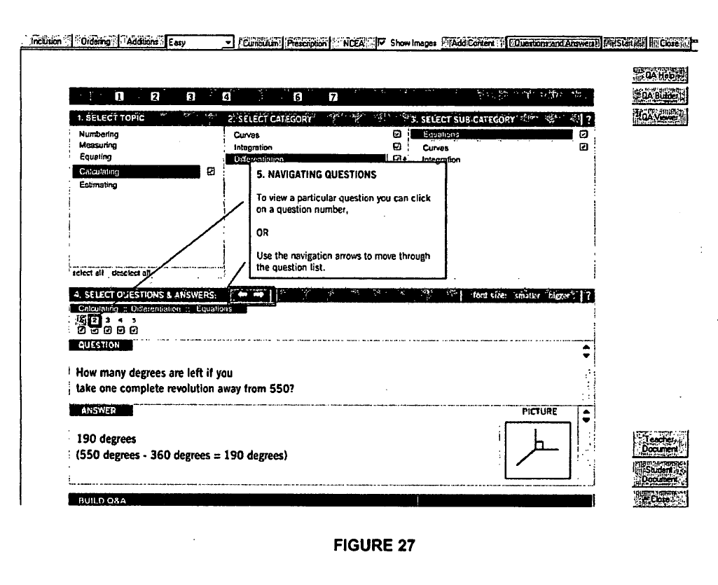

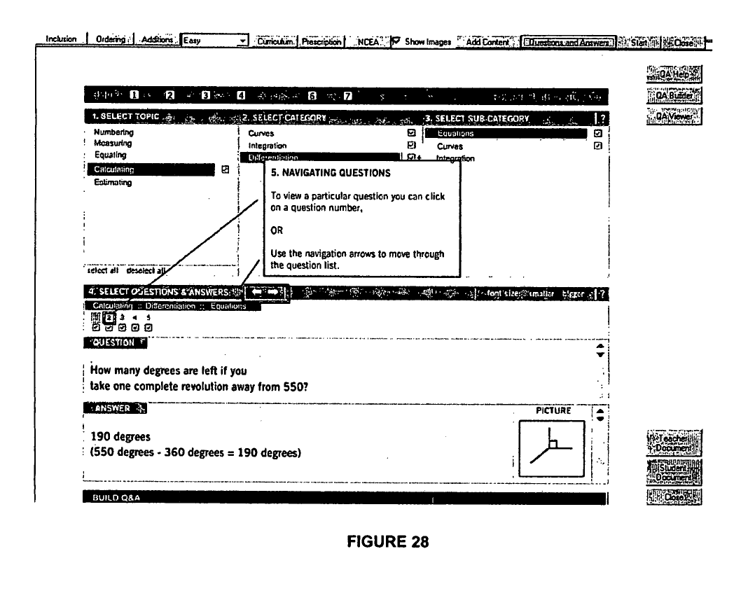

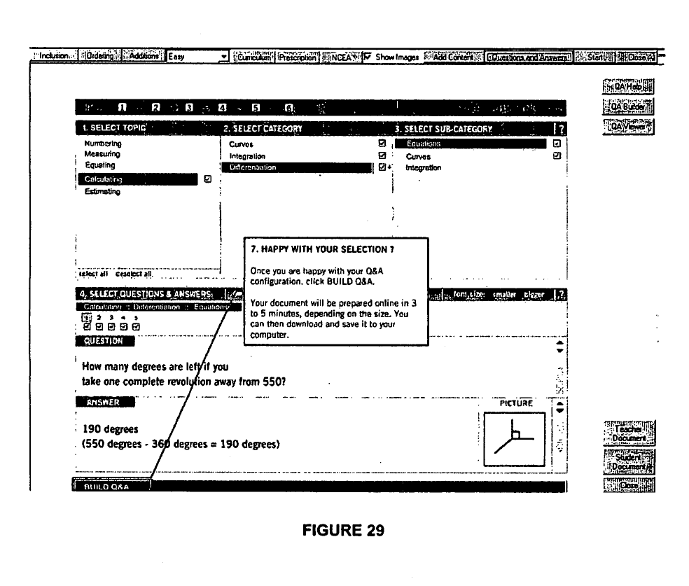

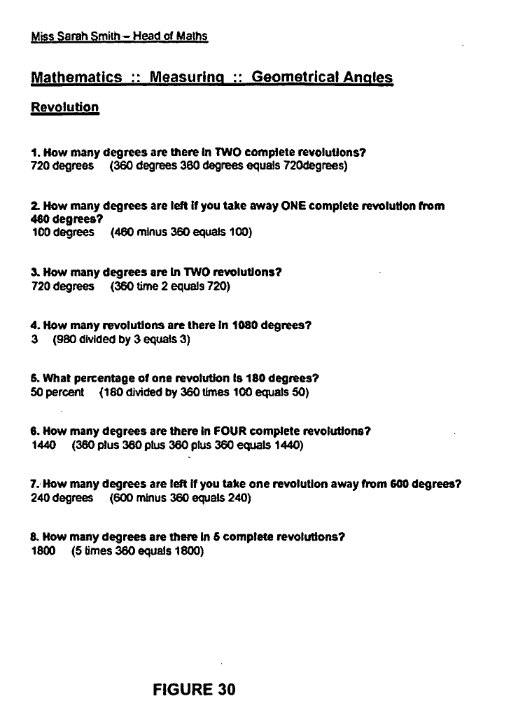

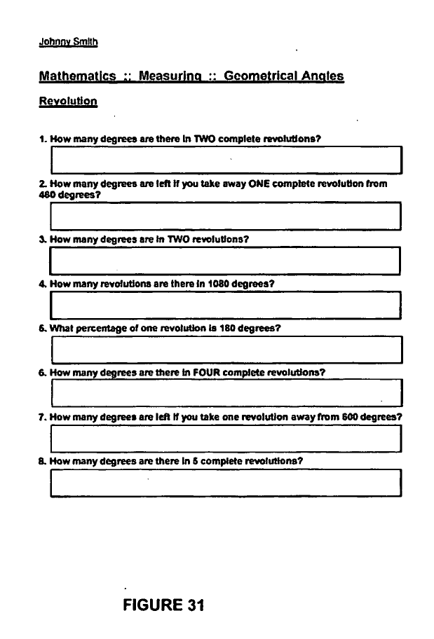

The invention also allows learners and teachers to build homework sheets based on the learner's curriculum and learning levels. FIGS. 23 to 29 illustrate this process. FIG. 30 shows an example teacher copy of a homework sheet produced by the invention with answers shown. FIG. 31 shows an example student copy of a homework sheet produced by the invention with spaces for the student to write their answers.

If a teacher or administrator should choose it is also possible to include links to remote media items as an instructional approach. Such remote media items may include for example, web pages, web broadcasts, video conference links and other such resources.

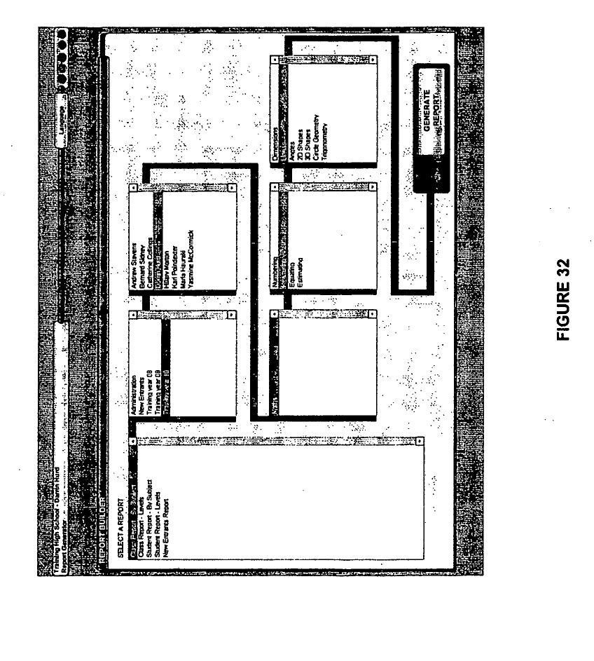

The invention is also able to produce reports for teachers, students or parents based on students and/or a Pedagogy. FIG. 32 shows the selection of data fields for generation of a report. Preferably this feature is only available to an administration user of the invention.

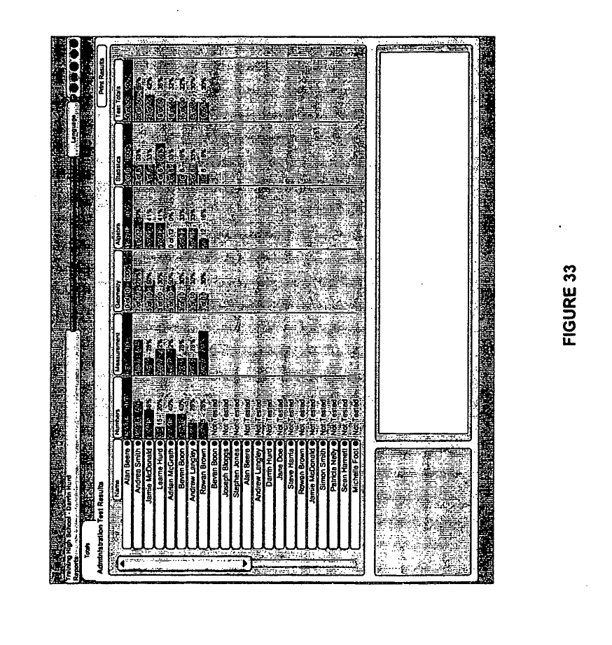

FIG. 33 shows a report generated for the students of a class and it shows each students assessment level for each pedagogy cluster in the subject Maths.

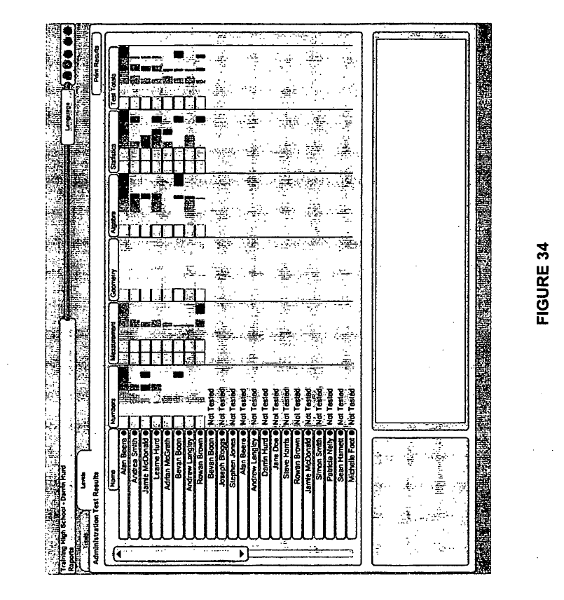

FIG. 34 shows a report generated for the students of a class and it shows each students learning level for each Pedagogy cluster.

The foregoing describes the invention including preferred forms thereof. Alterations and modifications as will be obvious to those skilled in the art are intended to be incorporated within the scope hereof, as defined by the accompanying claims.

1-26. (canceled)

27. A method of education comprising:
storing in computer memory one or more pedagogies representing topics to be mastered by a learner, one or more of the pedagogies including one or more pedagogy items representing sub-topics of the pedagogy;
for at least one of the pedagogy items, storing in computer memory one or more instructional approaches to the pedagogy item, the instructional approaches including one or more locally stored media items and/or one or more links to remote media items;
maintaining in computer memory a learner profile for at least one learner;
providing the learner with a learning interface to the one or more pedagogies stored in computer memory;
displaying to the learner via the learning interface, an indication of the learner's mastery of one or more of the pedagogy items;
updating the learner profile for the learner based on the learner's interaction with the one or more media items; and
refreshing the indication of the learner's mastery of the one or more pedagogy items when the learner profile for that learner is updated.

28. The method of claim 27, further including administering a pre-test to a learner before the learner accesses a pedagogy for the first time.

29. The method of claim 28, further including updating the learner profile for the learner according to the result of the pre-test.

30. The method of claim 27, further including storing in computer memory a prescribed level of mastery for the learner for one or more of the pedagogy items.

31. The method of claim 30, wherein the indication of the learner's mastery of pedagogy items in a pedagogy includes an indication of which pedagogy items the learner has mastered to the prescribed level of mastery.

32. The method of claim 27, wherein the indication of the learner's mastery of pedagogy items in a pedagogy includes an incremental indication of increases in the learner's level of mastery of one or more of the pedagogy items.

33. The method of claim 27, wherein a media item includes revision questions.

34. The method of claim 33, wherein the indication of the learner's mastery of a pedagogy item includes an indication of revision questions answered correctly.

35. The method of claim 33, wherein the indication of the learner's mastery includes an indication of the number of attempts made at a revision question.

36. The method of claim 27, further including administering a post-test to a learner when the learner indicates that they have completed the pedagogy.

37. The method of claim 36, further including displaying the results of the post-test to the learner.

38. The method of claim 27, wherein the learner is able to electively access any instructional approach for the pedagogy item at any time.

39. The method of claim 27, wherein the learner is able to electively access any pedagogy item at any time.

40. The method of claim 27, wherein a media item includes multi-media presentations.

41. The method of claim 27, wherein a media item includes interactive animations.

42. The method of any claim 27, wherein a media item includes text.

43. The method of claim 27, wherein a media item includes a video made by one or more learner.

44. The method of claim 27, wherein a media item comprises a web-page.

45. The method of claim 27, wherein a media item includes a live broadcast.

46. The method of claim 27, wherein a media item includes a video conference link.

47. The method of claim 27, wherein the one or more locally stored media items are available in more than one language.

48. The method of claim 27, wherein the one or more locally stored media items are available in more than one language simultaneously.

49. The method of claim 27, further including providing an administration interface whereby an administrator is able to access student progress data and modify the one or more pedagogies or any pedagogy item or media item therein.

50. The method of claim 27, wherein an administrator is able to select media items for inclusion in a learning approach from those media items available.

51. The method of claim 27, wherein the one or more pedagogies are grouped and indexed according to subject matter into pedagogy clusters.

52. The method of claim 51, wherein a learner is able to electively access one or more related pedagogies by first selecting a pedagogy cluster.

53. A system for education including:
a data memory configured to store:
one or more pedagogy data objects representing topics to be mastered by one or more learners;
one or more pedagogy item data objects stored in relation to one or more of the pedagogy data objects, the one or more pedagogy item data objects representing sub-topics for the related pedagogy data object;
one or more locally stored media items and/or one or more links to remote media items stored in relation to one or more of the pedagogy item data objects; and
at least one learner profile data object including data representing a level of mastery for a learner in relation to one or more of the pedagogy item data objects;
a display configured to display to a learner a learning interface to the one or more pedagogy data objects and related pedagogy item data objects stored in the data memory, wherein the learning interface includes an indication of the learner's level of mastery of one or more of the pedagogy item data objects as stored in the learner profile data object for the learner;
input means configured to allow the learner to interact with one or more of the media items for a pedagogy item data object; and
processing means configured to assess the learner's interaction with the one or more media items and to update the learner profile data object accordingly by adjusting the level of mastery for the related pedagogy item data object in the learner profile data object for the learner;
wherein the display is further configured to refresh the indication of the learner's level of mastery of the one ore more pedagogy item data objects when a level of mastery is adjusted in the learner profile data object.

54. The system of claim 53, wherein a pre-test is administered to a learner before the learner interacts with a pedagogy for the first time and the results of the pre-test are used to instantiate the level of mastery in the learner profile data object for at least one of the pedagogy items related to the pedagogy.

55. The system of claim 53, wherein the data memory is further configured to store a prescribed level of mastery for a learner for one or more of the pedagogy items.

56. The system of claim 53, wherein the indication of the learner's level of mastery for pedagogy item data objects includes an indication of the pedagogy item data objects for which the learner's related level of mastery is equal to or greater than the prescribed level of mastery.

57. The system of claim 53, wherein the indication of the learner's level of mastery for pedagogy item data objects includes an incremental indication of increases in the learner's level of mastery in relation to one or more of the pedagogy item data objects.

58. The system of claim 53, wherein a media item includes revision questions.

59. The system of claim 53, wherein the indication of the learner's level of mastery includes an indication of revision questions answered correctly.

60. The system of claim 59, wherein the indication of the learner's level of mastery includes an indication of the number of attempts made at a revision question.

61. The system of claim 53, wherein a media item includes multi-media presentations.

62. The system of claim 53, wherein a media item includes interactive animations.

63. The system of claim 53, wherein a media item includes text.

64. The system of claim 53, wherein a media item includes a video made by one or more learner.

65. The system of claim 53, wherein a media item includes a web-page.

66. The system of claim 53, wherein a media item includes a live broadcast.

67. The system of claim 53, wherein a media item includes a video conference link.

68. The system of claim 53, wherein the one or more locally stored media items are available in more than one language

69. The system of claim 53, wherein the one or more locally stored media items are available in more than one language simultaneously.

70. The system of claim 53, wherein the display is further configured to display an administration interface to an administrator through which the administrator can access student profile data objects.

71. The system of claim 70, wherein the administration interface further enables the administrator to modify the one or more pedagogy data objects.

72. The system of claim 70, wherein the administration interface further enables the administrator to modify the one or more pedagogy item data objects.

73. The system of claim 70, wherein the administration interface further enables the administrator to modify any media item.

74. The system of claim 53, wherein the one or more pedagogy data objects are grouped and indexed according to subject matter into pedagogy clusters.

75. The system of claim 53, wherein the learning interface allows the learner to electively access one or more related pedagogy items by first selecting a pedagogy cluster.

76. The system of claim 53, wherein learning interface allows the learner to electively access any pedagogy item data object at any time when accessing the related pedagogy data object.
